(19) United States
(12) Patent Application Publication
(10) Pub. No.: US 2025/0330839 A1
(43) Pub. Date: Oct. 23, 2025

(54) PROTOCOL-AWARE MULTI-DOMAIN NETWORK OPTIMIZATION USING DEEP LEARNING

(71) Applicant: VERIZON PATENT AND LICENSING INC., Basking Ridge, NJ (US)

(72) Inventors: Lap TSE, Marietta, GA (US); Massimiliano TROIANI, Frisco, TX (US); Samirkumar PATEL, Middlesex, NJ (US); Sudhakar Reddy PATIL, Flower Mound, TX (US); Anthony Clay REYNOLDS, Rhome, TX (US); Mark T. WATTS, Newport, RI (US); Ravi POTLURI, Coppell, TX (US); David TAFT, Keller, TX (US)

(73) Assignee: VERIZON PATENT AND LICENSING INC., Basking Ridge, NJ (US)

(21) Appl. No.: 18/640,533

(22) Filed: Apr. 19, 2024

(51) Int. Cl. H04W 24/02; G06N 20/00; H04L 41/16

(52) U.S. Cl. CPC H04W 24/02; G06N 20/00; H04L 41/16

(57) ABSTRACT

In some implementations, the techniques described herein relate to a method including: receiving input features associated with a cellular network that includes key performance indicators and metrics collected from computing devices in the cellular network; preprocessing the input features to generate input features; providing the input features to a machine learning model to generate a predicted user experience classification, wherein the machine learning model is trained using a dataset including a plurality of sets of input features and corresponding user experience labels; and performing one or more actions based on the predicted user experience classification, wherein performing one or more actions includes identifying a root cause of a user experience issue and generating a recommendation to modify the cellular network to address the root cause.

### BACKGROUND

The disclosed embodiments relate to optimizing network performance and user experience in communication systems using machine learning (ML) techniques. Modern communication networks support a wide variety of applications, each with specific performance requirements. Ensuring optimal user experience across these applications is challenging due to the complex interplay between user devices, radio access networks, transport networks, and application servers.

### BRIEF DESCRIPTION OF THE FIGURES

FIG. 1 is a block diagram illustrating a protocol-aware multi-domain network optimization system according to some of the disclosed embodiments.

FIG. 2 is a flow diagram illustrating a method for training a machine learning model using key performance indicators (KPIs) and health metrics from cellular network devices according to some of the disclosed embodiments.

FIG. 3 is a flow diagram illustrating a method for classifying the user experience of network device according to some of the disclosed embodiments.

FIG. 4 is a flow diagram illustrating a method for taking corrective actions based on the identified user experience issues to optimize end-to-end application performance according to some of the disclosed embodiments.

FIG. 5 is a block diagram illustrating a computing device showing an example embodiment of a computing device used in some of the disclosed embodiments.

### DETAILED DESCRIPTION

In the following disclosure, techniques are described that relate to methods, systems, devices, and computer-readable media for improving the operation of a cellular network based on holistic analysis of user experience at a protocol layer and an application layer.

In one implementation, a method is disclosed that includes receiving a set of input features associated with a cellular network. These input features include key performance indicators and metrics collected from various computing devices in the cellular network, such as user equipment, radio access network stations, and core network elements. In some cases, the key performance indicators and metrics that are collected are related to a WebRTC application and include metrics from the Session Traversal Utilities for Network Address Translation (STUN) protocol, such as jitter, latency, and packet loss measurements. The received set of input features may be preprocessed to generate a new set of input features that can be used as input to a machine learning model. The preprocessed set of input features may then be provided as input to a machine learning model, which generates a predicted user experience classification. The machine learning model may have been previously trained using a dataset that includes multiple sets of input features along with corresponding user experience labels. Based on a predicted user experience classification, one or more actions may be performed. These actions may involve identifying the root cause of a user experience issue and generating a recommendation to modify the cellular network in order to address that root cause.

The process of training a machine learning model can include several steps. First, a dataset may be collected, which includes multiple sets of input features and their corresponding user experience labels. The dataset may be created by collecting key performance indicators (KPIs) and metrics from computing devices in a cellular network. These KPIs and metrics may include measurements such as jitter, latency, packet loss, and throughput, as well as others, for protocols associated with the performance of an application. User experience labels may be assigned to a sets of collected key performance indicators and metrics. Once a dataset is prepared, it may be used to train a ML model, resulting in a trained ML model that can be used for predicting user experience classifications. In some cases, the ML model that is used may be a deep neural network.

The user experience labels that may be assigned to the sets of input features may be categorical labels that correspond to different levels of user experience quality. To identify a root cause of a user experience issue, the predicted user experience classification may be analyzed along with additional data collected from a cellular network. This additional data can include metrics related to devices, applications, the radio access network, and the core network. The root cause may then be determined by mapping patterns in the additional data to predefined root cause categories.

When generating a recommendation to address the identified root cause, the root cause may be provided as input to a recommendation engine. This recommendation engine may be designed to generate recommendations based on a mapping between root causes and corresponding actions. The generated recommendations may include actions such as adjusting radio resource allocation parameters, optimizing network configurations, scaling network resources, providing guidance to application developers, as well as others. The generated recommendation may then be translated into an action that can be executed in the cellular network. This translation process may involve generating configuration scripts, API calls, network policies or other changes. The translated action may then be executed by a network orchestrator.

The disclosure further discloses systems, devices, and non-transitory computer-readable storage media for tangibly storing computer program instructions capable of being executed by a computer processor for performing the above methods and various alternatives.

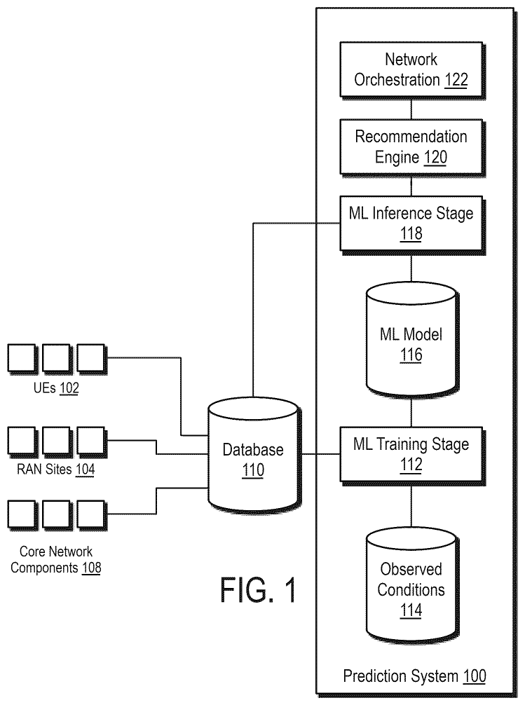

FIG. 1 is a diagram illustrating a protocol-aware multi-domain network optimization system according to some of the disclosed embodiments.

In the illustrated network, UEs 102, RAN sites 104, and core network components 108 form a cellular network. Through this network, UEs 102 and other end user devices (not illustrated) can communicate with each other, with other network components, and with external network services (not illustrated). As illustrated, a database 110 captures various metrics, KPIs, and other data during operation of the network. In some implementations, this database 110 can be part of the core network or an external database. A prediction system 100 is illustrated which includes an ML training stage 112 and an ML inference stage 118. During training, the ML training stage 112 retrieves metrics, KPIs, and other data from database 110 as well as observed conditions from observed conditions database 114 to build a training dataset that can predict the user experience for UEs 102. After training completes, the ML training stage 112 can save the model to the model storage 116. Next, during inference, the ML inference stage 118 can load the model and generate real-time features vectors based on data collected in database 110. The ML inference stage 118 can predict a user experience classification which is passed to a recommendation engine 120. The recommendation engine 120 can analyze various metrics related to the classification to identify a root cause of the user experience degradation (if any) and generate one or more recommended actions to take to improve the user experience. Recommendation engine 120 can then convert its recommendations to commands or scripts and provide these commands or scripts to network orchestrator 122. In response, the network orchestrator 122 can modify one or more aspects of the cellular network (e.g., core network or RAN) based on the commands.

In the illustrated network, UEs 102, such as smartphones, tablets, or other connected devices, can communicate with RAN sites 104, which can include base stations, such as eNodeBs (in 4G networks) or gNodeBs (in 5G networks). The RAN sites 104 can be connected to core network components 108, which can include entities such as the Packet Gateway (P-GW), Serving Gateway (S-GW), and Mobility Management Entity (MME). Together, the UEs 102, RAN sites 104, and core network components 108 can form a cellular network that can enable communication between UEs, other network components, and external network services.

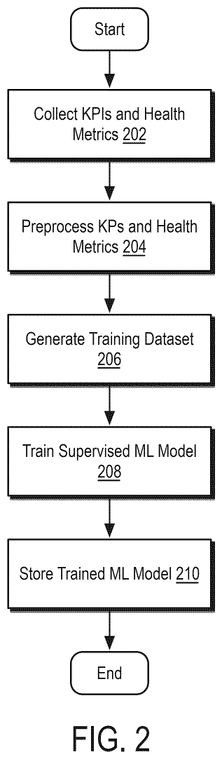

During network operation, various metrics, key performance indicators (KPIs), and other data can be collected from the UEs 102, RAN sites 104, and core network components 108 via probes, agent applications, or other techniques described in FIG. 2. This data can be stored in a database 110, which may be implemented as a relational database, NoSQL database, or similar storage mechanism. The database 110 can be part of the core network infrastructure or hosted on external servers, depending on scalability, security, and accessibility requirements.

The prediction system 100 can include two main stages: an ML training stage 112 and a ML inference stage 118. The ML training stage 112 performs operations described in FIG. 2 (which is not repeated here), where metrics, KPIs, and other data can be retrieved from the database 110 and combined with observed conditions from an observed conditions database 114 to build a training dataset. The observed conditions database 114 can store labeled data that associates network and device metrics with known user experience classifications or issues. The training dataset can then be used to train a machine learning model, such as a deep neural network (DNN), recurrent neural network (RNN), or ensemble model, to predict the user experience of UEs 102 based on the input features. The trained model can then be saved to a ML model storage 116, which can be a file system or a model registry like MLflow® or TensorFlow®. Further detail on the operations of ML training stage 112 are described more fully in the description of FIG. 2 which is incorporated herein in its entirety.

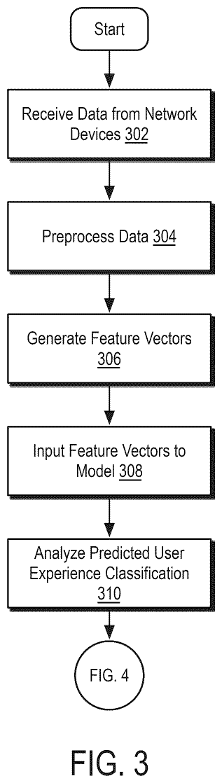

During the ML inference stage 118, the trained model can be loaded from the ML model storage 116, and real-time feature vectors can be generated based on the latest data collected in the database 110. The ML inference stage 118 can use the loaded model to predict a user experience classification for each feature vector. The predicted classifications can then be passed to a recommendation engine 120. Further detail on the operations of ML inference stage 118 are described more fully in the description of FIG. 3 which is incorporated herein in its entirety.

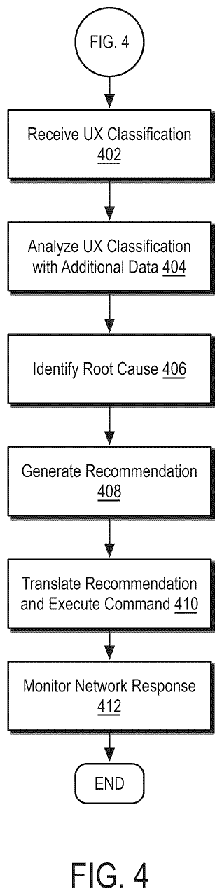

The recommendation engine 120 can analyze various metrics related to the predicted user experience classification to identify the root cause of any user experience degradation. This analysis can include comparing the metrics against predefined thresholds, historical baselines, or domain knowledge encoded in expert systems. Based on the identified root cause, the recommendation engine 120 can generate one or more recommended actions to improve the user experience. These recommendations can include adjusting radio resource allocation, optimizing network configurations, scaling network resources, providing guidance to application developers, or similar recommendations. To translate the recommendations into actionable steps, the recommendation engine 120 can convert the recommendations into commands or scripts that can be executed by a network orchestrator 122. This translation process may involve generating configuration templates, API calls, or network policies. Network orchestrator 122 can receive these commands or scripts and modify the relevant aspects of the cellular network, including UEs 102, RAN sites 104 or core network components 108, to implement the recommended optimizations. Further detail on the operations of recommendation engine 120 and network orchestrator 122 are described more fully in the description of FIG. 4 which is incorporated herein in its entirety.

In some implementations the prediction system 100 may be implemented using a microservices architecture, with each component (e.g., ML training stage, ML inference stage, recommendation engine) running as a separate service. These services can be containerized using technologies like Docker and orchestrated using platforms like Kubernetes.

The protocol-aware multi-domain network optimization system enables a closed-loop, data-driven approach to improving user experience in cellular networks. By continuously collecting data, predicting user experience issues, identifying root causes, and generating optimization recommendations, the system can adapt to the dynamic nature of mobile networks and proactively address performance challenges.

FIG. 2 is a flow diagram illustrating a method for training a machine learning model using key performance indicators (KPIs) and health metrics from cellular network devices according to some of the disclosed embodiments.

In step 202, the method can include collecting KPIs and health metrics from cellular network devices. In some implementations, the cellular network devices may include user equipment, end user devices, applications, core network elements, radio access network base stations and others.

In some implementations, UEs and end user devices refer to the devices used by end users to access network services, such as smartphones, tablets, laptops, or other connected devices. For such devices, a software agent or monitoring application can be installed on the UEs and end user devices. In some implementations, this agent or application can capture relevant metrics and send them to a prediction system (100) as discussed in FIG. 1. In some implementations, the metrics captured by UEs and end user devices can include, but is not limited to, CPU/GPU utilization, battery temperature, memory usage, signal strength, signal-to-noise ratio, modulation and coding scheme, and congestion indicators, application-specific KPIs (e.g., round-trip times, throughput, error rates), and metrics related to protocols used by the applications, such as WebRTC, STUN, Transmission Control Protocol (TCP), User Datagram Protocol (UDP), and Real-Time Messaging Protocol (RTMP). Metrics related to protocols can include jitter, latency, packet loss, throughput measurements and others. To enable data collection, applications on UEs and end user devices can be instrumented or modified to expose relevant metrics and KPIs. This can be achieved through the use of APIs, libraries, or SDKs that facilitate the collection and reporting of application-specific metrics. The data collected from applications can include, but is not limited to, application performance metrics such as response times, error rates, and throughput, as well as user experience metrics that directly impact user perception, such as video quality (e.g., frame rate, resolution), audio quality (e.g., bit rate, latency), and user interaction metrics (e.g., click-to-play time).

In some implementations, core network elements include components such as a Packet Gateway (P-GW), Serving Gateway (S-GW), Mobility Management Entity (MME), and other elements responsible for handling user authentication, authorization, and data transfer in a cellular network. To enable data collection, core network elements can be modified to include probes or monitoring agents that capture relevant metrics. These probes can be deployed at various points in the network to collect data as traffic passes through the core network. The data collected from core network elements can include, but is not limited to, network performance metrics such as latency, jitter, packet loss, and throughput measurements at the core network level, resource utilization metrics like CPU usage, memory usage, and network interface statistics for core network elements, and protocol-specific metrics related to protocols used in the core network, such as GTP (GPRS Tunneling Protocol) and Diameter.

In some implementations, RAN base stations, such as eNodeBs or gNodeBs, provide wireless connectivity to UEs and end user devices and manage radio resources. To enable data collection, RAN base stations can be modified to include built-in monitoring capabilities or can be integrated with external monitoring tools. In some implementations, the data collected from RAN base stations can include, but is not limited to, radio network metrics like signal strength, signal-to-noise ratio (SNR), modulation and coding scheme (MCS), and other radio-specific metrics, resource utilization metrics such as resource block allocation, channel utilization, and power consumption, connectivity metrics including the number of connected devices, handover statistics, and radio link failures, and protocol-specific metrics related to protocols used in the RAN, such as the Radio Resource Control (RRC) protocol.

In step 204, the method can include preprocessing the collected data. In some implementations, pre-processing can be performed to correct missing values, normalize and scale input features, and perform additional feature engineering.

Given the diverse range of data sources in the cellular network environment, feature engineering can include combining and transforming metrics from different network elements to create representative features. For example, data from end user devices, such as device metrics and application specific KPIs, can be aggregated and correlated with data from the core network and RAN base stations to create composite features that capture the end-to-end performance and user experience. This can involve techniques such as time synchronization, data alignment, and statistical summarization to ensure that the features accurately reflect the state of the network and the user experience at any given point in time. Additionally, feature engineering may involve extracting domain-specific features that are particularly relevant to the cellular network environment. This can include calculating derived metrics or ratios that provide insights into network performance, resource utilization, and user behavior. For instance, features such as the average number of connected devices per base station, or the distribution of traffic across different network protocols can be engineered to capture important characteristics of the cellular network. By leveraging domain knowledge and expertise, the feature engineering process can help create a rich and informative feature set that enables effective analysis and modeling of the complex interactions within the cellular network ecosystem.

In step 206, the method can include generating a training dataset based on the collected data and assigning labels to feature vectors in the training dataset.

In some implementations, the generation of feature vectors involves combining the preprocessed metrics and features into a structured format suitable for machine learning models. In some implementations, each feature vector can represent a snapshot of the network state and user experience at a given point in time, capturing relevant information from various data sources such as end user devices, applications, core network elements, and RAN base stations, as discussed above.

In some implementations, the method can include assigning labels to the feature vectors. In some implementations, these labels can represent various aspects of the user experience or network performance. Examples of types of labels are provided below. In some implementations, the method can assign one or multiple labels teach feature vector, depending on the implementations of the underlying machine learning algorithm (e.g., single-class versus multi-class).

In some implementations, the labels can include user experience (UX) labels that capture the overall quality of the user experience for specific applications or services. For example, categorical labels such as “Very High quality,” “High quality,” “Medium quality,” “Mediocre quality,” or “Low quality” (or equivalent numeric labels) can be assigned to each feature vector based on the corresponding network metrics and KPIs. In some implementations, the labeling process may involve defining thresholds or ranges for different metrics, such as jitter, latency, or throughput, and mapping them to the appropriate quality categories. Using WebRTC as one example, the method can include mapping WebRTC metrics to user experience labels, where a jitter of less than 5 milliseconds and a latency of less than 5 milliseconds are associated with a “Very High quality” label for video and controller responsiveness.

Alternatively, or in conjunction with the foregoing, the labels can include protocol-specific labels that can be identified based on the performance of specific protocols (e.g., WebRTC, STUN, TCP, UDP, RTMP, etc.). In such a scenario, these labels may indicate whether the protocol is functioning optimally or experiencing issues. For instance, labels like “Normal,” “Degraded,” or “Faulty” (or equivalent numeric labels) can be assigned to feature vectors based on protocol-specific metrics and thresholds. In some implementations, the labeling process may include analyzing, for example, the STUN protocol and using metrics like jitter and latency to determine the quality of the user experience.

Alternatively, or in conjunction with the foregoing, the labels can include network performance labels that can represent the overall performance of the network or specific network segments. In such an implementation, these labels may indicate whether the network is operating at an acceptable level or experiencing congestion, failures, or other issues. Examples of network performance labels could be “Optimal,” “Suboptimal,” “Congested,” or “Faulty” (or equivalent numeric labels). In these implementations, the labeling process may involve analyzing metrics from the core network elements and RAN base stations (e.g., resource utilization, error rates, or handover statistics) and mapping them to the appropriate performance categories.

In some implementations, the labeling process may involve collaborating with subject matter experts, analyzing historical data, and conducting user surveys or feedback sessions to establish the ground truth for the user experience and network performance. In other implementations, unsupervised learning techniques can also be employed to generate labels for the feature vectors. Unsupervised learning algorithms, such as clustering or anomaly detection, can help identify patterns and structures in the data without relying on predefined labels. For example, clustering algorithms like K-means or hierarchical clustering can be applied to the feature vectors to group similar data points together based on their inherent characteristics. Each resulting cluster can then be analyzed and assigned a label based on the common properties or behavior of the data points within that cluster. For instance, clusters exhibiting high jitter, latency, or packet loss can be labeled as “Poor Quality,” while clusters with optimal metrics can be labeled as “Good Quality.” Similarly, anomaly detection algorithms can be used to identify data points that deviate significantly from the normal patterns, indicating potential issues or anomalies in the network. These anomalous data points can be labeled as “Anomalous” or “Outliers.” By leveraging unsupervised learning techniques, the labeling process can be partially, or fully, automated to reduce reliance on manual labeling and enabling the discovery of underlying patterns and structures in the data.

In some implementations, the training dataset generation process can also incorporate considerations and techniques to ensure a comprehensive and representative dataset. For example, the method may involve capturing device-level metrics, such as CPU utilization, memory usage, and battery temperature, in addition to network-level metrics. These device-level metrics can provide further insights into the performance and health of the end-user devices and contribute to the overall assessment of the user experience. By including these metrics in the feature vectors, the training dataset can capture a more comprehensive view of the factors influencing user experience. Furthermore, the “closed loop” approach enables a holistic analysis of user experience and network performance. When generating the training dataset, the method can ensure that the feature vectors encompass metrics from all relevant levels and sources to facilitate this integrated analysis.

Certainly, in some implementations, the method can also extend the data collection and labeling approach to other protocols and applications beyond the examples discussed (e.g., WebRTC and STUN). The same principles of collecting relevant metrics, defining quality thresholds, and assigning labels can be applied to a wide range of protocols and applications, such as RTMP for video streaming or V2X communication for vehicle-to-everything interactions. By incorporating data from multiple protocols and applications into the training dataset, the machine learning models can learn to predict user experience and network performance across different scenarios.

Moreover, in some implementations, the method can adopt an iterative and continuous improvement approach to dataset generation. As new data becomes available and the understanding of the relationships between metrics and user experience evolves, the training dataset can be regularly updated and expanded. This iterative approach ensures that the machine learning models are trained on the most up-to-date and relevant data, enabling them to adapt to changing network conditions and user behaviors over time.

By incorporating these additional considerations and techniques, the method can generate a training dataset that comprehensively captures the complexities and interdependencies of the cellular network ecosystem. The resulting dataset will serve as a solid foundation for developing accurate and robust machine learning models that can predict user experience and network performance across a wide range of scenarios and applications.

Once the feature vectors are labeled and the training dataset created, it can be used to train supervised machine learning models, as will be described next.

In step 208, the method can include training a supervised machine learning model using the training dataset. In the context of predicting user experience and network performance in a cellular network, several types of models can be considered.

In some implementations, deep neural networks (DNNs), particularly feedforward neural networks, can be used to identify complex non-linear relationships between the input features and the target labels. As such, DNNs can handle a large number of input features and can be designed with multiple hidden layers to learn hierarchical representations of the data. The output layer of the DNN can be configured based on the type of target labels, such as using a softmax activation for multi-class classification or a linear activation for regression.

In some implementations, recurrent neural networks (RNNs), such as Long Short-Term Memory (LSTM) or Gated Recurrent Unit (GRU) networks, can be used to process sequential or time-series data as many sessions may be temporal in nature. In some implementations, RNNs can capture temporal dependencies and patterns in the metrics collected over time. Such networks can be useful for modeling the evolution of network conditions and user experience across different time steps.

In some implementations, ensemble learning methods can be used to combine multiple individual models to make predictions. For example, random forests, gradient boosting machines (GBMs), or stacking can be used to ensemble different models. Ensemble methods can help improve prediction accuracy and robustness by accessing the strengths of multiple models and reducing overfitting. For instance, a random forest can be used to combine decision trees trained on different subsets of the training data, while GBMs can iteratively train weak models and combine them to create a strong predictive model.

In yet other implementations, hybrid models can be employed to combine different types of machine learning algorithms to leverage their respective strengths. For example, a hybrid model can use a combination of DNNs and RNNs, where the DNN extracts relevant features from the input data, and the RNN captures temporal dependencies. The output of the RNN can be further processed by a feedforward neural network to make the final predictions. Hybrid models can be tailored to the specific characteristics of the training dataset and can potentially provide improved performance.

When training the supervised machine learning model, the training dataset can be divided into training, validation, and test sets. The model can be trained on the training set and the validation set can be used to tune hyperparameters and assess model performance during training. In some implementations, a test set is used for final evaluation to estimate the model's performance on unseen data. In some implementations, the choice of evaluation metrics depends on the problem type (e.g., classification or regression) and can include metrics such as accuracy, precision, recall, F1 score, mean squared error, or mean absolute error, as discussed above with respect to mapping of metrics to quality categories.

In step 210, the method can include storing the model for later inference stages (described in the following FIG. 3).

Once the model has been trained and validated, it can be serialized and saved to a persistent storage medium, such as a file system or a database. The stored model can include the learned model parameters, architecture details, and any necessary metadata. This allows the model to be loaded and used for inference in subsequent stages of the process, such as predicting user experience and network performance metrics for new, unseen data points. The stored model can be deployed in various environments, such as cloud servers or edge devices, depending on the specific requirements and constraints of the system.

FIG. 3 is a flow diagram illustrating a method for classifying the user experience of network device according to some of the disclosed embodiments.

In step 302, the method can include receiving data from various network devices, including UEs, end user devices, applications, core network elements, and radio access network base stations. In some implementations, the data may be received in real-time or substantially real-time. The types of data collected in step 302 may be substantially similar or identical to the types of data described in the description of steps 202 and 204 of FIG. 2, the description of which is not repeated herein.

In step 304, the method can include preprocessing the data. In some implementations, the preprocessing uses techniques such as feature engineering, normalization, and data alignment, similar to those used in the training phase described in step 204 of FIG. 2, the description of which is not repeated herein.

In step 306, the method can include generating input feature vectors based on the preprocessed data, capturing relevant information from various data sources and protocols (e.g., WebRTC, STUN, TCP, UDP, and RTMP) as described in step 206 of FIG. 2, the description of which is not repeated herein.

In step 308, the method can include inputting the input feature vectors into the trained machine learning model (trained using the method of FIG. 2), which can predict a value indicative of a user experience or network performance metrics based on the input features.

In step 310, the method can include analyzing the model's output to determine the predicted user experience classification. For example, the method can map the predicted value to a categorical label such as “Very High quality,” “High quality,” “Medium quality,” “Mediocre quality,” or “Low quality,” based on predefined thresholds or ranges.

The output of the machine learning model, which was trained using the method described in FIG. 2, can be a numerical value or a set of values that indicate the predicted user experience or network performance. In some implementations, this output can be a single scalar value, such as a score ranging from 0 to 1, where higher values indicate better user experience. In other implementations, the output can be a vector of values, each corresponding to a specific aspect of user experience or network performance, such as jitter, latency, or packet loss.

To map the model's output to a user experience classification, the method can compare the predicted value or values against predefined thresholds or ranges. These thresholds or ranges can be determined based on domain knowledge, industry standards, or empirical analysis of historical data. For example, if the model's output is a scalar value between 0 and 1, the method may define the following ranges:
0.8 to 1.0: “Very High quality”
0.6 to 0.8: “High quality”
0.4 to 0.6: “Medium quality”
0.2 to 0.4: “Mediocre quality”
0.0 to 0.2: “Low quality”

In this example, if the model's output for a given input feature vector is 0.85, the method would classify the predicted user experience as “Very High quality.”

In implementations where the model's output is a vector of values, the method can consider each value separately or combine them into an aggregate score using techniques such as weighted averaging or principal component analysis. The resulting scalar value can then be compared against predefined thresholds or ranges to determine the user experience classification. The specific thresholds or ranges used for classification may be adjusted based on the particular application, network conditions, or business requirements. In some implementations, the method may employ more granular or continuous classifications, such as percentile ranks or z-scores, to provide an alternative representation of the predicted user experience.

Once classifying the user experience, the method can proceed to the following method depicted in FIG. 4.

FIG. 4 is a flow diagram illustrating a method for taking corrective actions based on the identified user experience issues to optimize end-to-end application performance according to some of the disclosed embodiments.

In step 402, the method can include receiving the user experience classification from the output of the machine learning model, as described in FIG. 3. The user experience classification is a high-level indicator of the overall user experience quality, for example, represented as a categorical label such as “Very High quality,” “High quality,” “Medium quality,” “Mediocre quality,” or “Low quality.” Thru the user experience classification, the method obtains a high-level indication of the predicted user experience quality, which can be used as a starting point for further analysis and decision-making in the subsequent steps of the method.

In step 404, the method can include analyzing the received user experience classification in conjunction with additional data collected from various network components and devices, such as UEs, end-user devices, applications, radio access network, and core network elements.

In some implementations, the method can utilize different approaches to analyze additional data after receiving a higher-level classification of the user experience.

In one implementation, the method can continuously collect a wide range of metrics and data from various network components and devices, regardless of the user experience classification. This comprehensive data set can include metrics related to jitter, latency, packet loss, throughput, signal strength, resource utilization, and other relevant factors. By having access to this extensive data set, the method can perform a thorough analysis and correlation of metrics to identify potential issues and their root causes.

In another implementation, the machine learning model used for user experience classification can include additional information beyond a class label, such as feature importance or contribution scores. In this implementation, this information can be leveraged to guide the selection of relevant metrics for analysis. For example, if the model indicates that jitter is the most influential factor in determining a “Low quality” classification, the method can prioritize the analysis of jitter-related metrics and data.

In another implementation, the method can incorporate domain knowledge and heuristic rules to determine which metrics and data to analyze based on the user experience classification. This approach can include mapping the classification to a predefined set of metrics or data sources that are known to be relevant for that particular class. For instance, if the classification is “Low quality,” the method can trigger the analysis of metrics related to jitter, latency, and packet loss, as these factors are commonly associated with poor user experience.

In step 406, the method can include determining the root cause of the identified user experience issues.

In some implementations, the method can compare the collected metrics against predefined thresholds or historical baselines. For example, if the user experience classification is “Low quality,” the method can examine the metrics related to jitter, latency, packet loss, and throughput to see if they exceed the acceptable thresholds or deviate significantly from the historical norms. By identifying the specific metrics that are outside the expected ranges, the method can narrow down the potential root causes.

Alternatively, or in conjunction with the foregoing, the method can encode the expertise and experience of network engineers and domain experts into rule-based systems or knowledge bases. For instance, if the method detects high jitter and packet loss in the radio access network metrics, along with congestion indicators, it may suggest a capacity issue or interference in the wireless channel. Similarly, if the core network metrics show high latency and resource utilization, it may indicate a bottleneck or misconfiguration in the network infrastructure.

Alternatively, or in conjunction with the foregoing, the method can also employ machine learning techniques for root cause analysis. In some implementations, the method may utilize a second machine learning model specifically trained for this purpose. Such a model can take the collected metrics and data as input features and learn to predict the root causes based on historical examples and labeled data. The model can be trained on a dataset that includes various network scenarios, user experience issues, and their corresponding root causes. By learning the patterns and relationships in this data, the model can identify the most likely root causes for new instances of user experience issues. In yet another implementation, unsupervised learning techniques, such as clustering and anomaly detection, can also be applied in the root cause analysis process. Clustering algorithms can group similar instances of user experience issues based on their associated metrics and data patterns. Each cluster can represent a different type of issue or root cause. By analyzing the characteristics of each cluster, the method can identify the common factors contributing to specific types of user experience issues. Anomaly detection techniques can help identify unusual or abnormal patterns in the metrics and data that deviate from the expected behavior, potentially indicating the presence of underlying issues.

In step 408, the method can include generating specific recommendations for network optimization based on the identified root causes.

In various implementations, the generated recommendations can cover a wide range of actions, depending on the specific root causes identified. The following are some, but not all, recommendations that may be associated with root causes detected in step 406.

The method may recommend adjusting radio resource allocation or parameters to alleviate congestion, interference, or capacity issues in the radio access network. The method may recommend optimizing network configurations, such as routing tables, quality of service (QOS) settings, or security policies, to improve network performance and reduce latency. First, the method may recommend scaling up or redistributing network resources, such as bandwidth, processing power, or storage, to accommodate increased traffic demands or service requirements. The method may recommend implementing caching or content delivery optimizations to reduce latency and improve application responsiveness. The method may recommend new or updated software updates, patches, or configuration changes for end-user devices or applications to address compatibility issues or performance bottlenecks. The method may recommend network architecture or topology changes, such as the deployment of edge computing nodes or the redistribution of network functions, to optimize service delivery and reduce latency.

In another implementation, the method may utilize a large-language model (LLM) or similar generative model generate recommendations. In these implementations, the LLM may comprise a retrieval-augmented generation (RAG) LLM that can search a vectorized database of knowledge that includes, among other aspects, the above recommendations. For example, the RAG-based LLM may have access to manuals, API documentation, and other documents that engineers would use to improve network operations. Using this knowledge, the LLM can synthesize actions to unforeseen problems.

In step 410, the method can include translating the prioritized recommendations into one or more commands and executing the commands through a network orchestration tool. In some implementations, generating commands may include generating configuration scripts, API calls, or network policies.

In some implementations, the method can store a set of pre-configured commands or command templates to execute for a given recommendation. In some implementations, the parameters of the recommendation can be extracted and used to customize a given command (e.g., via a command template) before being executed.

In other implementations, the method may leverage a similar RAG-based LLM. In this context, the RAG-based LLM can further be trained on a corpus of network configuration templates, scripts, and API documentation to enable it to generate accurate and actionable commands based on the provided recommendations. In this implementation, a RAG-based LLM can retrieve relevant information from its knowledge base, such as configuration templates or API specifications, based on the given recommendations. It then can use this retrieved information to guide the generation process to generate syntactically correct commands that are aligned with the intended network optimizations. For example, if a recommendation suggests adjusting radio resource allocation parameters in the Radio Access Network (RAN) to optimize performance, the RAG-based LLM can retrieve the appropriate configuration templates for the specific RAN technology (e.g., 4G LTE or 5G NR) and generate the necessary configuration scripts or API calls to apply the recommended changes. Similarly, if a recommendation involves tuning transport network configurations to improve data flow and reduce bottlenecks, the RAG-based LLM can generate the appropriate network policies or rules using standardized languages or formats, such as YANG models or TOSCA templates, based on the retrieved knowledge from its training corpus.

The generated commands can then be executed through network orchestration tools or platforms, automating the implementation of the recommended optimizations across the network. This integration with network orchestration frameworks, such as software-defined networking (SDN) controllers or network function virtualization (NFV) orchestrators, enables the method to programmatically apply the generated configurations, scripts, or policies to the relevant network components.

In step 412, the method can include monitoring the impact of the implemented changes on user experience, using feedback from the machine learning model and other monitoring tools, to assess the effectiveness of the optimization efforts.

In some implementations, this monitoring process can include collecting and analyzing data from various sources to evaluate how the implemented changes have influenced the KPIs and user experience metrics. In addition to the machine learning model, the method can utilize other monitoring tools and techniques to gather data on network performance, application behavior, and user feedback. This can include collecting metrics from network probes, analyzing log files, conducting user surveys, or leveraging crowdsourced data from end-user devices. The machine learning model, which was used earlier to predict the user experience based on network and device metrics, can be employed again to provide feedback on the impact of the optimizations. By comparing the predicted user experience before and after the changes, the method can quantify the effectiveness of the implemented optimizations.

Furthermore, in some implementations, the method can iteratively refine and adapt the optimization strategies based on the monitoring results and any new data or insights collected over time. If the implemented changes do not yield the expected improvements or if new issues emerge, the method can trigger additional rounds of analysis, root cause identification, and recommendation generation.

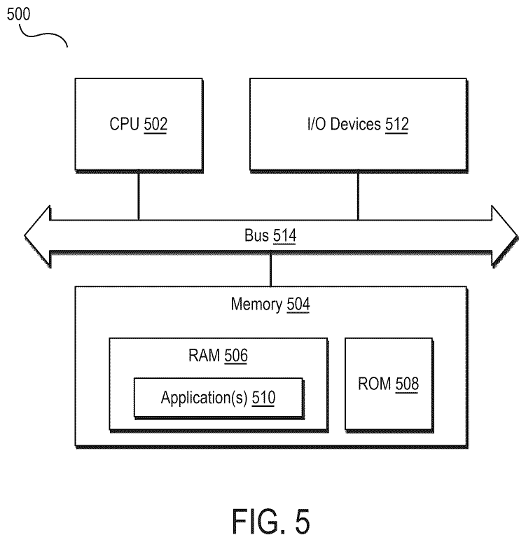

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving, by a computing device, a set of input features associated with a cellular network, the set of input features comprising key performance indicators and metrics collected from computing devices in the cellular network, the computing devices comprising one or more of user equipment, radio access network stations, and core network elements;
preprocessing the set of input features to generate a set of input features;
providing the set of input features as input to a machine learning model to generate a predicted user experience classification, wherein the machine learning model is trained using a dataset comprising a plurality of sets of input features and corresponding user experience labels; and
performing one or more actions based on the predicted user experience classification, wherein performing one or more actions comprises identifying a root cause of a user experience issue and generating a recommendation to modify the cellular network to address the root cause.

2. The method of claim 1, wherein training the machine learning model comprises:
collecting the dataset comprising the plurality of sets of input features and corresponding user experience labels by:
collecting the key performance indicators and metrics from the computing devices in the cellular network, wherein the key performance indicators and metrics include one or more of jitter, latency, packet loss, and throughput measurements for protocols associated with a performance of an application, and
assigning user experience labels to sets of collected key performance indicators and metrics; and
training the machine learning model using the dataset to generate a trained machine learning model.

3. The method of claim 2, wherein the machine learning model comprises a deep neural network.

4. The method of claim 2, wherein the user experience labels comprise categorical labels corresponding to different levels of user experience quality.

5. The method of claim 1, wherein identifying the root cause of the user experience issue comprises:
analyzing the predicted user experience classification and additional data collected from the cellular network, wherein the additional data includes one or more of device metrics, application metrics, radio access network metrics, and core network metrics; and
determining the root cause based on a mapping between patterns in the additional data and predefined root cause categories.

6. The method of claim 1, wherein generating the recommendation to address the root cause comprises:
providing the root cause as input to a recommendation engine, wherein the recommendation engine is configured to generate recommendations based on a mapping between root causes and corresponding actions; and
receiving the recommendation from the recommendation engine, wherein the recommendation comprises one or more of adjusting radio resource allocation parameters, optimizing network configurations, scaling network resources, and providing guidance to application developers.

7. The method of claim 1, further comprising:
translating the recommendation into an action to be executed in the cellular network, wherein translating the recommendation comprises generating one or more of configuration scripts, API calls, and network policies; and
executing the action by a network orchestrator.

8. The method of claim 1, wherein the key performance indicators and metrics are related to a WebRTC application and include STUN protocol metrics, and wherein the STUN protocol metrics comprise one or more of jitter, latency, and packet loss measurements.

9. A non-transitory computer-readable storage medium for tangibly storing computer program instructions capable of being executed by a processor, the computer program instructions defining steps of:
receiving a set of input features associated with a cellular network, the set of input features comprising key performance indicators and metrics collected from computing devices in the cellular network, the computing devices comprising one or more of user equipment, radio access network stations, and core network elements;
preprocessing the set of input features to generate a set of input features;
providing the set of input features as input to a machine learning model to generate a predicted user experience classification, wherein the machine learning model is trained using a dataset comprising a plurality of sets of input features and corresponding user experience labels; and
performing one or more actions based on the predicted user experience classification, wherein performing one or more actions comprises identifying a root cause of a user experience issue and generating a recommendation to modify the cellular network to address the root cause.

10. The non-transitory computer-readable storage medium of claim 9, wherein training the machine learning model comprises:
collecting the dataset comprising the plurality of sets of input features and corresponding user experience labels by:
collecting the key performance indicators and metrics from the computing devices in the cellular network, wherein the key performance indicators and metrics include one or more of jitter, latency, packet loss, and throughput measurements for protocols associated with a performance of an application, and
assigning user experience labels to sets of collected key performance indicators and metrics; and
training the machine learning model using the dataset to generate a trained machine learning model.

11. The non-transitory computer-readable storage medium of claim 10, wherein the machine learning model comprises a deep neural network and wherein the user experience labels comprise categorical labels corresponding to different levels of user experience quality.

12. The non-transitory computer-readable storage medium of claim 9, wherein identifying the root cause of the user experience issue comprises:
analyzing the predicted user experience classification and additional data collected from the cellular network, wherein the additional data includes one or more of device metrics, application metrics, radio access network metrics, and core network metrics; and
determining the root cause based on a mapping between patterns in the additional data and predefined root cause categories.

13. The non-transitory computer-readable storage medium of claim 9, wherein generating the recommendation to address the root cause comprises:
providing the root cause as input to a recommendation engine, wherein the recommendation engine is configured to generate recommendations based on a mapping between root causes and corresponding actions; and
receiving the recommendation from the recommendation engine, wherein the recommendation comprises one or more of adjusting radio resource allocation parameters, optimizing network configurations, scaling network resources, and providing guidance to application developers.

14. The non-transitory computer-readable storage medium of claim 9, the steps further comprising:
translating the recommendation into an action to be executed in the cellular network, wherein translating the recommendation comprises generating one or more of configuration scripts, API calls, and network policies; and
executing the action by a network orchestrator.

15. The non-transitory computer-readable storage medium of claim 9, wherein the key performance indicators and metrics are related to a WebRTC application and include STUN protocol metrics, and wherein the STUN protocol metrics comprise one or more of jitter, latency, and packet loss measurements.

16. A device comprising:
a processor for execution of a set of instructions to:
receive a set of input features associated with a cellular network, the set of input features comprising key performance indicators and metrics collected from computing devices in the cellular network, the computing devices comprising one or more of user equipment, radio access network stations, and core network elements;
preprocess the set of input features to generate a set of input features;
provide the set of input features as input to a machine learning model to generate a predicted user experience classification, wherein the machine learning model is trained using a dataset comprising a plurality of sets of input features and corresponding user experience labels; and
perform one or more actions based on the predicted user experience classification, wherein performing one or more actions comprises identifying a root cause of a user experience issue and generating a recommendation to modify the cellular network to address the root cause.

17. The device of claim 16, wherein training the machine learning model comprises:
collecting the dataset comprising the plurality of sets of input features and corresponding user experience labels by:
collecting the key performance indicators and metrics from the computing devices in the cellular network, wherein the key performance indicators and metrics include one or more of jitter, latency, packet loss, and throughput measurements for protocols associated with a performance of an application, and
assigning user experience labels to sets of collected key performance indicators and metrics; and
training the machine learning model using the dataset to generate a trained machine learning model.

18. The device of claim 16, wherein identifying the root cause of the user experience issue comprises:
analyzing the predicted user experience classification and additional data collected from the cellular network, wherein the additional data includes one or more of device metrics, application metrics, radio access network metrics, and core network metrics; and
determining the root cause based on a mapping between patterns in the additional data and predefined root cause categories.

19. The device of claim 16, wherein generating the recommendation to address the root cause comprises:
providing the root cause as input to a recommendation engine, wherein the recommendation engine is configured to generate recommendations based on a mapping between root causes and corresponding actions; and
receiving the recommendation from the recommendation engine, wherein the recommendation comprises one or more of adjusting radio resource allocation parameters, optimizing network configurations, scaling network resources, and providing guidance to application developers.

20. The device of claim 16, further comprising instructions to:
translate the recommendation into an action to be executed in the cellular network, wherein translating the recommendation comprises generating one or more of configuration scripts, API calls, and network policies; and
execute the action by a network orchestrator.
